(19) United States
(12) Patent Application Publication
(10) Pub. No.: US 2008/0117159 A1
(43) Pub. Date: May 22, 2008

(54) Method for driving liquid crystal display with scanning backlight module

(75) Inventor: Yung-Chiang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/986,400

(22) Filed: Nov. 21, 2007

(30) Foreign Application Priority Data
Nov. 21, 2006 (TW) 95143000

(51) Int. Cl. G09G 3/36

(52) U.S. Cl. 345/99

(57) ABSTRACT

An exemplary method for driving an LCD with an LCD panel and a plurality of light sources controlled by an inverter is provided. The liquid crystal panel includes a gate driving circuit, a timing controller, and a plurality of scanning lines. The method includes a: the timing controller controlling the gate driving circuit to generate scanning signals during a frame time period; step b: the timing controller controlling the inverter to successively turn on and turn off the light sources, when one of the light source is turned on, light beams emitted by the light source illuminating the liquid crystal panel to form a brightness region thereon, thereby the scanning signals being provided to the scan lines corresponding to the brightness region; when the light source is turned off, the scanning signals being provided to the scan lines corresponding to the brightness region again.

### FIELD OF THE INVENTION

The present invention relates to liquid crystal displays (LCDs), and more particularly to a method for driving an LCD with a scanning backlight module.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by many to have the potential to completely replace CRT (cathode ray tube) monitors and televisions.

FIG. 4 is a schematic, pre-assembled view of a conventional LCD. The LCD 1 includes an LCD panel 10 and a backlight module 12.

Also referring to FIG. 5, this is a block diagram of the LCD 1 showing circuitry of driving circuits thereof. The LCD panel 10 includes a gate driving circuit 14, a data driving circuit 16, a timing controller 18, a plurality of parallel scan lines 101, a plurality of parallel data lines 103, a plurality of pixel electrodes 105, a plurality of thin film transistors (TFTs) 107, and a plurality of common electrodes 109.

The timing controller 18 is electrically coupled to the gate driving circuit 14 and the data driving circuit 16, respectively. The gate driving circuit 14 drives the scan lines 101, and the data driving circuit 16 drives the data lines 103. The scan lines 101 are orthogonal to and isolated from the data lines 103. The scan lines 101 and data lines 103 thereby cooperatively define a plurality of pixel regions 108 arranged in a regular array. In each pixel region 108, a pixel electrode 105 and a corresponding common electrode 109 are disposed generally opposite each other. Each TFT 107 is positioned near a crossing of a corresponding scan line 101 and a corresponding data line 103. A gate electrode of the TFT 107 is electrically coupled to the scan line 101, and a source electrode of the TFT 107 is electrically coupled to the data line 103. Further, a drain electrode of the TFT 107 is electrically coupled to the corresponding pixel electrode 105.

The backlight 12 includes an inverter 15 and a plurality of lamps 13. In operation, the inverter 15 provides voltage signals to drive the lamps 13 to emit light beams, thereby illuminating the LCD panel 10.

FIG. 6 shows waveform diagrams of scanning signals transmitting in the LCD panel 10. Under the control of the timing controller 18, the gate driving circuit 14 respectively provides a plurality of scanning signals 102 to the plurality of scan lines 101 during a frame time period T. Taking a scan line G2 as an example, when the scanning signal 102 is transmitted to the scan line G2, the TFTs 107 electrically coupled to the scan line G2 are turned on.

Simultaneously, under the control of the timing controller 18, the data driving circuit 16 provides a plurality of data signals to the plurality of data lines 103, wherein the data signals are high-voltage signals. During the time the scanning signals 102 are transmitted to the scan line G2, the data signals are transmitted to the pixel electrodes 105 via the source electrode and the drain electrode of each of the TFTs 107 electrically coupled to the scan line G2. Then the pixel regions 108 coupled to the scan line G2 display images, and maintain the data signals for a total period of time equal to one frame time period T.

That is, before the next scanning signals 104 are provided to the scan line G2, the pixel regions 108 coupled to the scan line G2 maintain the data signals.

In the next frame time period (not labeled), the scanning signals 104 are provided to the scan line G2 to turn on the TFTs 107 electrically coupled to the scan line G2, and simultaneously the next data signals are provided to the pixel electrodes 105 via the source electrode and the drain electrode of each of the TFTs 107 electrically coupled to the scan line G2. Thereby, the pixel regions 108 coupled to the scan line G2 display next images, and maintain the next data signals for a total period of time equal to one frame time period T.

However, when the LCD panel 10 displays a same image for a long time, the so-called image sticking phenomenon may be generated on the LCD panel 10. When LCD panel 10 switches to display a next image, the data signals maintained in the pixel regions 108 cannot be rapidly released, and offset voltages are liable to be generated between the pixel electrodes 105 and the common electrodes 109 of the pixel regions 108. The offset voltages may impact the display quality of the LCD panel 10 during the next time period, such that the LCD panel 10 exhibits image sticking.

It is desired to provide a method for driving an LCD which can overcome the above-described deficiencies.

### SUMMARY

An exemplary method for driving a liquid crystal display is provided. The liquid crystal display includes a liquid crystal panel and a plurality of light sources, whereby the liquid crystal panel includes a gate driving circuit, a timing controller, and a plurality of scanning lines. The light sources are controlled by an inverter. The method includes step a: the timing controller controlling the gate driving circuit to generate scanning signals during a frame time period; step b: during the same frame time period, the timing controller controlling the inverter to successively turn on and turn off the light sources from a first one of the light sources to a last one of the light sources, whereby when one of the light sources is turned on, light beams emitted by the light source illuminate the liquid crystal panel to form a bright region on the liquid crystal panel corresponding to the light source, and first scanning signals are provided to a plurality of the scan lines corresponding to the bright region; and when the one of the light sources is turned off, the scanning signals are provided to the same plurality of scan lines that corresponded to the bright region; and step c: repeating steps a and b during next frame time period.

Other novel features and advantages of the present driving method will become more apparent from the following detailed description when taken in conjunction with the accompanying drawings, in which:

### BRIEF DESCRIPTION OF THE DRAWINGS

FIG. 1 is a schematic, pre-assembled view of an LCD used in a method according to an exemplary embodiment of the present invention;

FIG. 2 is a block diagram of the LCD of FIG. 1, showing abbreviated circuitry of driving circuits thereof;

FIG. 3 shows waveform diagrams of scanning signals and backlight controlling signals transmitting in the LCD of FIG. 1;

FIG. 4 is a schematic, pre-assembled view of a conventional LCD;

FIG. 5 is a block diagram of the LCD of FIG. 4, showing abbreviated circuitry of driving circuits thereof; and

FIG. 6 shows waveform diagrams of scanning signals transmitting in the LCD of FIG. 4.

### DETAILED DESCRIPTION OF PREFERRED EMBODIMENTS

Reference will now be made to the drawings to describe preferred and exemplary embodiments of the present invention in detail.

FIG. 1 is a schematic, pre-assembled view of an LCD according to an exemplary embodiment of the present invention. The LCD 2 includes an LCD panel 20 and a backlight module 22. The backlight module 22 is disposed adjacent to the LCD panel 20 for illuminating the LCD panel 20.

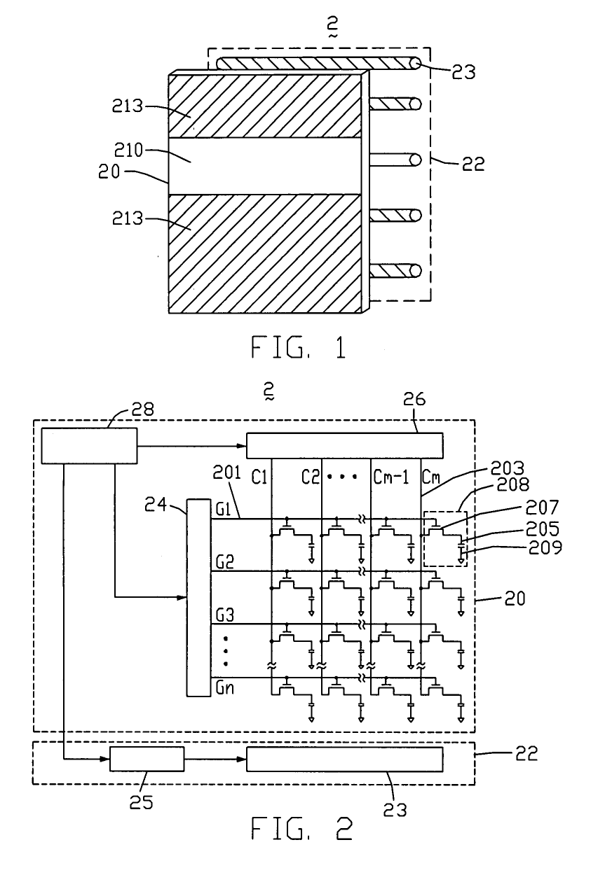

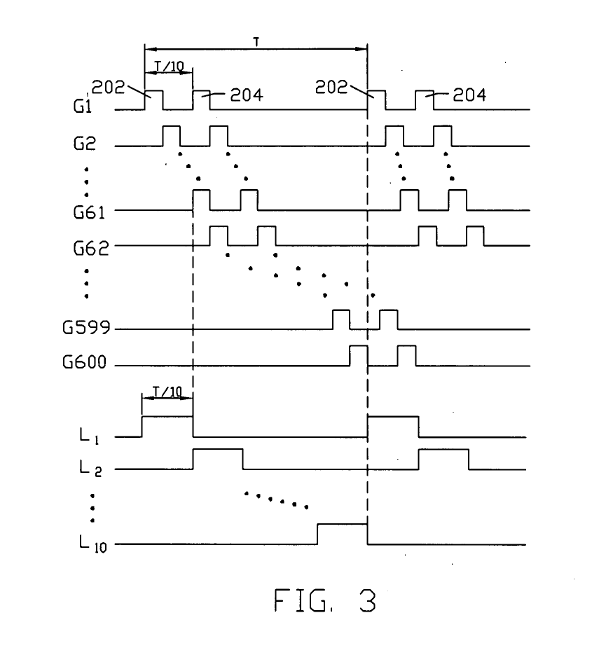

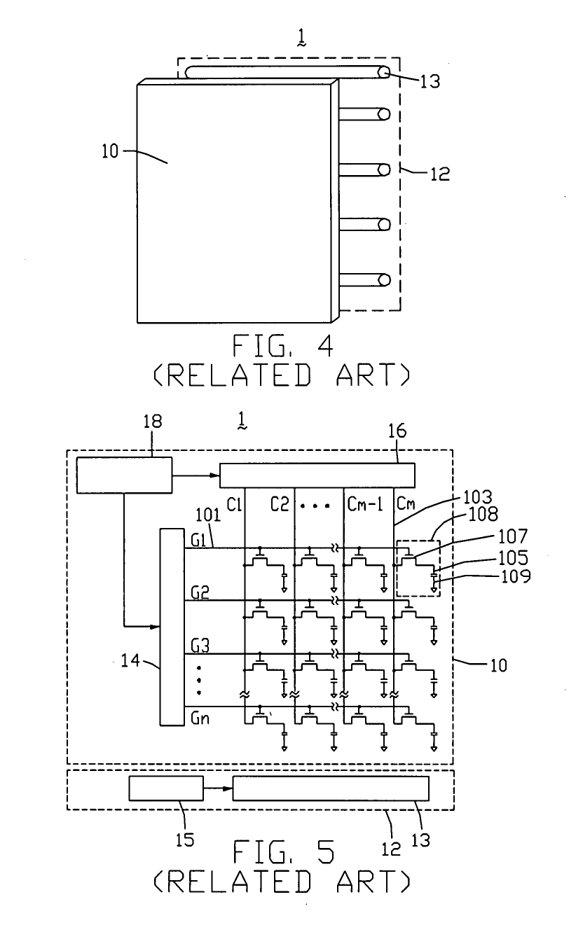

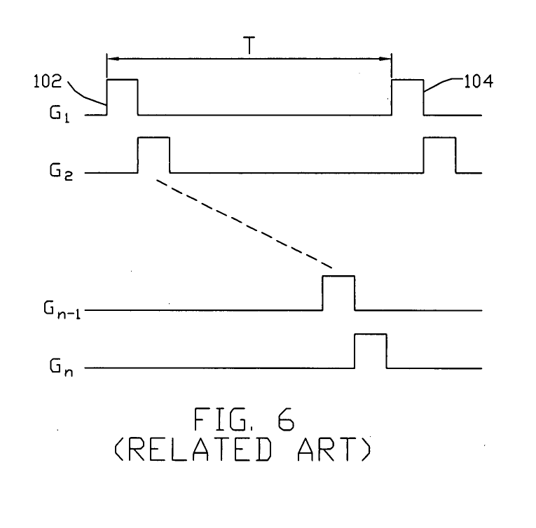

Also referring to FIG. 2, this is a block diagram of the LCD 2 showing circuitry of driving circuits thereof. The LCD panel 20 includes a gate driving circuit 24, a data driving circuit 26, a timing controller 28, a plurality of parallel scan lines 201, a plurality of parallel data lines 203, a plurality of pixel electrodes 205, a plurality of thin film transistors (TFTs) 207, and a plurality of common electrodes 209. The scan lines 201 are orthogonal to and isolated from the data lines 203. The scan lines 201 and data lines 203 thereby cooperatively define a plurality of pixel regions 208 arranged in a regular array. In each pixel region 208, a pixel electrode 205 and a corresponding common electrode 209 are disposed generally opposite each other.

The backlight 22 includes an inverter 25 and a plurality of parallel lamps 23. The lamps 23 may be cold cathode fluorescent lamps (CCFLs). In the embodiment illustrated in FIG. 1, there are five lamps 23. In another embodiment (not illustrated) provided for the purpose of describing waveforms of signals in the LCD 2 (see below), there are ten lamps 23.

The timing controller 28 is electrically coupled to the gate driving circuit 24, the data driving circuit 16, and the inverter 25, respectively. The gate driving circuit 24 drives the scan lines 201, and the data driving circuit 26 drives the data lines 203. Further, the inverter 25 drives the lamps 23. Each TFT 207 is positioned near a crossing of a corresponding scan line 201 and a corresponding data line 203. A gate electrode of the TFT 207 is electrically coupled to the scan line 201, and a source electrode of the TFT 207 is electrically coupled to the data line 203. Further, a drain electrode of the TFT 207 is electrically coupled to the corresponding pixel electrode 205.

In operation, the lamps 23 are driven by the inverter 25, with the lamps 23 successively being turned on and turned off one by one. When one of the lamps 23 is turned on, the light beams emitted by the lamp 23 illuminate the LCD panel 20 so as to form a bright region 210 thereon. The bright region 210 corresponds to certain of the scan lines 201. At the same time, other lamps 23 are turned off so as to form several dark regions 213 on the LCD panel 20.

Also referring to FIG. 6, waveform diagrams of scanning signals and backlight controlling signals transmitting in the LCD panel 20 are shown. In this embodiment, for the purpose of describing waveforms of the signals in the LCD panel 20, it is assumed that the LCD panel 20 includes six hundred columns of scan lines 201 and ten lamps 23. G1˜G600 illustrate waveform diagrams of scanning signals in scan lines G1˜G600 of the scan lines 201. L1˜L10 illustrate waveform diagrams of backlight controlling signals in respect of lamps L1˜L10 of the lamps 23. The scan lines G1˜G60 correspond to the lamp L1, the scan lines G61˜G120 correspond to the lamp L2, and so on according to this progressional relationship, through to the scan lines G541˜G600 corresponding to the lamp L10.

An exemplary method for driving the LCD panel 20 is as follows:

Step 1: The timing controller 28 provides first controlling signals to the gate driving circuit 24, to control the gate driving circuit 24 to generate first scanning signals 202 and second scanning signals 204 in a frame time period T. At the same time, the timing controller 28 provides second controlling signals to the data driving circuit 26, to control the data driving circuit 26 to generate a plurality of data signals. The first scanning signals 202 are applied to the scan lines G1˜G600 in a frame time period T.

Step 2: The timing controller 28 provides backlight controlling signals to the inverter 25 to turn on the first lamp L1. The first lamp L1 emits light beams to illuminate the LCD panel 20 and form a bright region 210 thereon, the bright region 210 corresponding to scan lines G1˜G60. At the same time, the first scanning signals 202 are provided to the scan lines G1˜G60, and the data signals are provided to the data lines 203.

The scan line G2 is taken here as an example for illustrating operating processes. When the first scanning signals 202 are provided to the scan line G2, the TFTs 207 coupled to the scan line G2 are turned on. That is, the source electrode is electrically coupled to the drain electrode in each of the TFTs 207 coupled to the scan lines G2. Then the data signals are transmitted to the pixel electrodes 205 coupled to the scan lines G2 via the activated TFTs 207, so as to display images at the corresponding pixel regions 208. The scan line G2 corresponds to the bright region 210.

The time period of the first lamp 23 being in an on state is equal to the time period of applying the first scanning signals 202 to the scan lines G1˜G60. The time period of applying the first scanning signals 202 to the scan lines G1˜G60 is 60T/600=T/10. That is, the time period of the first lamp 23 being in an on state is also T/10. Similarly, each of the lamps 23 is turned on for a respective time period of T/10.

Step 3: The backlight controlling signals control the inverter 25 to turn off the first lamp L1 and turn on the second lamp L2, so as to define a dark region 213 on the LCD panel 20 corresponding to the scan lines G1˜G60, and a bright region 210 on the LCD panel 20 corresponding to the scan lines G61˜G120. The second scanning signals 204 are provided to the scan lines G1˜G60.

When the second scanning signals 204 are provided to the scan lines G1˜G60, the TFTs 207 coupled to the scan line G2 are conductive, so as to release the data signals maintained in the pixel regions 208 coupled to the scan line G2. At this time, the scan line G2 is at the dark region 213, and a viewer may not notice image generation associated with the releasing process. The second scanning signals 204 are applied to the scan lines G1˜G60 when the corresponding region of the LCD panel 20 is in a dark state. Therefore the time interval between the first and second scanning signals 202, 204 should larger than or equal to the time period of T/k, where k is the number of lamps 23 (k≧1).

The steps for driving the scan lines G121˜G600 and the lamps L3˜L10 are similar to Step 3 described above. With similar operating processes, the LCD panel 20 finishes displaying images in one frame time period T. In order to drive the LCD panel 20 to continuously display an image or images, the steps described above are simply repeated.

According to the method described above, the data signals maintained in the pixel regions 208 are timely released. Even if the LCD panel 20 is used to display a same image for a long time, offset voltages are not generated in the pixel regions 208. That is, the image sticking phenomenon is avoided.

Various modifications and alterations to the above mechanisms and processes are possible. For example, the gate driving circuit 24 may generate more than two successive scanning signals applied to each scan line 201. In such case, the data signals maintained in the pixel regions 208 can be thoroughly release, so as to completely avoid the image sticking phenomenon. In addition, when the number of columns of the scan lines 201 and the number of lamps 23 vary, the time interval between the backlight controlling signals and the scanning signals can be appropriately adjusted. That is, when the number of lamps 23 is k (k≧1), the time period of each of the lamps 23 being in an on state is equal to the time period of T/k, and the time interval between two adjacent scanning signals should be greater than or equal to the time period of T/k. Furthermore, the lamps 23 may instead be other physically linear light sources. Moreover, the equivalent of linear light sources can formed by a plurality of point light sources, such as a plurality of light emitting diodes connected in series.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A method for driving a liquid crystal display, the liquid crystal display comprising a liquid crystal panel and a plurality of light sources, the liquid crystal panel comprising a gate driving circuit, a timing controller, and a plurality of scanning lines, the light sources being controlled by an inverter, the method comprising:
step a: the timing controller controlling the gate driving circuit to generate scanning signals during a frame time period;
step b: during the same frame time period, the timing controller controlling the inverter to successively turn on and turn off the light sources from a first one of the light sources to a last one of the light sources, wherein when one of the light sources is turned on, light beams emitted by the light source illuminate the liquid crystal panel to form a bright region on the liquid crystal panel corresponding to the light source, and first scanning signals are provided to a plurality of the scan lines corresponding to the bright region;
and when said one of the light sources is turned off, second scanning signals are provided to the same plurality of scan lines that corresponded to the bright region;
step c: repeating steps a and b during a next frame time period.

2. The method as claimed in claim 1, wherein each of the light sources is a cold cathode fluorescent lamp.

3. The method as claimed in claim 1, wherein each of the light sources is a plurality of light emitting diodes arranged in alignment with each other.

4. The method as claimed in claim 1, wherein the number of light sources is k, the frame time period is T, and a time interval between two adjacent first and second scanning signals is T/k.

5. The method as claimed in claim 1, wherein the number of light sources is k, the frame time period is T, and a time interval between two adjacent first and second scanning signals is greater than T/k.

6. The method as claimed in claim 1, wherein the number of light sources is k, the frame time period is T, and a time period during which each of the light sources is turned on is T/k.
